(19) United States
(12) Patent Application Publication
(10) Pub. No.: US 2017/0014768 A1
(43) Pub. Date: Jan. 19, 2017

(54) HIGHLY PERMEABLE DOUBLE-SKINNED FORWARD OSMOSIS MEMBRANE FOR ANTI-FOULING IN THE EMULSIFIED OIL-WATER SEPARATION PROCESS

(71) Applicants: National University of Singapore, Singapore (SG); Kraton Polymers U.S. LLC, Houston, TX (US)

(72) Inventors: Hoang Hanh Phuoc Duong, Thuwal (SA); Tai-Shung Chung, Singapore (SG)

(21) Appl. No.: 15/124,755

(22) PCT Filed: Mar. 26, 2015
(86) PCT No.: PCT/SG2015/000095

§ 371 Date: Sep. 9, 2016

Related U.S. Application Data
(60) Provisional application No. 61/970,736, filed on Mar. 26, 2014.

(51) Int. Cl. B01D 61/00; B01D 65/08; B01D 71/66; B01D 69/12; B01D 71/56; B01D 71/42; C02F 1/44; B01D 67/00

(52) U.S. Cl. CPC B01D 61/002; C02F 1/445; B01D 65/08; B01D 67/0006; B01D 69/125; B01D 71/56; B01D 71/42; B01D 71/66; C02F 2101/32

(57) ABSTRACT

A double-skinned membrane that includes a polymeric support having a thickness of 20 to 500 nm, a first surface and a second surface opposed to each other; a polymeric thin film layer having a thickness of 1 to 1000 nm and covering the first surface; and a sulfonated pentablock copolymer layer having a thickness of 1 to 1000 nm and covering the second surface. Also disclosed is a method of preparing the above-described double-skinned membrane.

### BACKGROUND OF THE INVENTION

Forward osmosis (FO), a naturally driven process without hydraulic pressure, has attracted attention in recent years for its unique applications in production of clean water. In a FO process, clean water is separated from contaminants via an asymmetric semi-permeable membrane.

Conventional FO membranes have an asymmetric structure that normally consists of a dense skin, i.e., an active skin, and a porous support. There are two operating modes in a FO process depending upon the membrane orientation. In the first mode, the active skin of the membrane faces a draw solution while feed solutes enter the porous support and accumulate inside due to rejection by the active skin. In the second mode, the active skin layer faces a feed solution and the porous support is immersed in a draw solution.

FO operation in the first mode is preferred as it has a higher water flux. Yet, the feed solutes accumulated in the support cause higher solute concentrations than those in the feed solution, leading to an internal concentration polarization (ICP). ICP counteracts the driving force of the FO process and decreases the water flux rate of the membrane. In addition, fouling worsens as foulants in the feed solution enter easily into the support. Fouling is particularly severe in treating feeds containing large amounts of foulants, e.g., an oil-contaminated water.

There is a need to develop a high-performance fouling-resistant. FO membrane for use in separating oil and water from an emulsion.

### SUMMARY OF THE INVENTION

This invention relates to a double-skinned membrane that is not only highly fouling resistant but also exhibits an unexpectedly high water flux rate and an unexpectedly high salt/oil rejection rate. As such, it is suitable as a FO membrane for use in treating highly foulant-containing feeds.

One aspect of this invention relates to a double-skinned membrane that includes a polymeric support having a first surface and a second surface opposed to each other, a polymeric thin film layer covering the first surface, and a sulfonated pentablock copolymer layer covering the second surface.

The polymeric support has a thickness of 20 to 500 μm; the polymeric thin film layer has a thickness of 1 to 1000 nm; and the copolymer layer has a thickness of 1 to 1000 nm. Preferably, the polymeric support has a thickness of 40-70 μm; the polymeric thin film layer has a thickness of 50-500 nm; and the copolymer layer has a thickness of 50-500 nm.

The polymeric support can be made of cellulose acetate, cellulose diacetate, cellulose triacetate, cellulose propionate, cellulose butyrate, cellulose tributyrate, polyacrylonitrile, polyvinyl alcohol, polysulfone, sulfonated polysulfone, polyethersulfone, sulfonated polyethersulfone, polyetherimide, polyamide, polyimide, polyamide-imide, or a combination thereof.

Examples of the thin film layer include a polyamide layer and a polyamide-imide layer.

In one embodiment, the polymeric support is made of polyacrylonitrile and the thin film layer is a polyamide layer.

One embodiment of the membrane has a pure water permeability (PWP) rate of 0.1 to 10 Lm⁻²h⁻¹bar⁻¹, a NaCl rejection rate of 60 to 99%, and an oil rejection rate of 20 to 99.9%. Preferably, the PWP rate is higher than 1 Lm⁻²h^{-l}bar⁻¹, the NaCl rejection rate is higher than 85%, and the oil rejection rate is higher than 95%.

Another aspect of this invention relates to a method of preparing the above-described double-skinned membrane. The method includes the following steps: (i) mixing 10 to 25 wt % of a polymer and 0.1 to 35 wt % of a pore former in a solvent to form a polymer solution, (ii) casting the polymer solution on a plate, (iii) immersing the plate in water to coagulate the polymer and deplete the pore former and the solvent from the polymer solution, thus forming a polymeric support having a first surface and a second surface opposed to each other, (iv) coating the first surface of the support with a polymeric thin film layer, and (v) coating the second surface of the support with a sulfonated pentablock copolymer layer. The double-skinned membrane thus formed has a sandwich-layered structure: a polymeric thin film layer, a polymeric support, and a sulfonated pentablock copolymer layer.

Examples of the polymer and the polymeric thin film layer are enumerated above. The pore former can be ethylene glycol, polyethylene glycol, or lithium chloride. Examples of the solvent include ethanol, dimethylformamide (DMF), dimethylacetamide, N-methyl-2-pyrrolidone (NMP), dimethylsulfoxide, 1,3-dimethyl-2-imidazolidinone, and a combination thereof.

The details of the invention are set forth in the description below. Other features, objects, and advantages of the invention will be apparent from the description and from the claims.

### DETAILED DESCRIPTION

Within this invention is a double-skinned membrane that includes a polymeric thin film layer and a sulfonated pentablock copolymer layer, each of the two layers serving as a dense skin. The double-skinned structure minimizes ICP effect and internal fouling as the thin film layer rejects draw solutes and the copolymer layer rejects foulants in a feed solution.

The double-skinned membrane can be prepared using hydrophilic polyacrylonitrile support, which is sandwiched between a thin film skin for salt rejection and a copolymer skin for emulsified oil particle rejection. The copolymer skin typically has less density than the thin film skin.

One embodiment of the thin film skin contains polyamide generated via interfacial polymerization. The copolymer skin formed of self-assembled sulfonated pentablock copolymer has a mean pore diameter of 5-15 nm. For emulsified oil-water treatment, the double-skinned membrane performs superiorly with much lower fouling propensity, compared with a single-skinned membrane.

Described below are exemplary procedures for preparing the double-skinned membrane of this invention, namely, a polymeric support sandwiched by a polymeric thin film layer and a sulfonated pentablock copolymer layer.

Initially, the polymeric support can be prepared in three steps. First, a polymer and a pore former are mixed in a solvent to form a polymer solution. Second, the polymer solution is cast on a plate. Third, the plate having the polymer solution cast thereon is immersed in water. Water is miscible with the polymer solvent without dissolving the polymer. As such, the polymer starts to coagulate to form a polymeric support as a result of the solvent being gradually mixed with the water and depleted from the polymer solution. The pore former acts to generate pores in the polymeric support.

The polymeric support thus prepared has a first surface and a second surface opposed to each other.

The first surface of the polymeric support is then coated with a polymeric thin film layer. Below is an example of how a polyamide thin film layer is formed on the first surface via interfacial polymerization between m-phenylenediamine (MPD) and trimesoyl chloride hexane (TMC).

The polymeric support is fixed in a frame so that only the first surface of the support is exposed to the reactants. A 0.1 to 10 wt % (e.g., 1 to 2 wt %) MPD aqueous solution is cast on the exposed surface. Excess water droplets on the surface are removed by a filter paper. Subsequently, a 0.001 to 2 wt % (e.g., 0.05 to 0.2 wt %) TMC hexane solution is cast on top of the MPD aqueous solution to initiate polymerization.

As a result, a polyamide thin film layer is formed on the first surface of the polymeric support.

Finally, the second surface of the polymeric support is coated with a copolymer layer. This final step can be performed by casting a 0.05 to 10 wt % (e.g., 0.5 to 3 wt %) sulfonated pentablock copolymer solution on the surface.

A double-skinned membrane having a polymeric support, a polymeric thin film layer, and a sulfonated pentablock copolymer layer is thus formed.

In one embodiment of preparing the double-skinned membrane, the polymer is polyacrylonitrile, the pore former is lithium chloride, the solvent is a mixture of ethanol and DMF, the interfacial polymerization is achieved by casting a 1 to 2 wt % MPD aqueous solution and a 0.05 to 0.2 wt % trimesoyl chloride hexane solution, and the second coating step is performed by casting a 0.5 to 3 wt % sulfonated pentablock copolymer solution. Preferably, the interfacial polymerization is achieved by casting a 1.5 wt % MPD aqueous solution and a 0.05 wt % trimesoyl chloride hexane solution, and the second coating step is performed by casting a 2 wt % sulfonated pentablock copolymer solution.

The specific examples below are to be construed as merely illustrative, and not limitative of the remainder of the disclosure in any way whatsoever.

Without further elaboration, it is believed that one skilled in the art can, based on the description herein, utilize the present invention to its fullest extent.

### EXAMPLE

### Preparation of a Double-Skinned Membrane

A double-skinned membrane was prepared following the procedure described below.

A polymeric support containing polyacrylonitrile (PAN), was first prepared via a phase inversion process as follows.

A polymer solution, prepared by mixing 14 wt % PAN, 4 wt % LiCl, 7 wt % ethanol, and 75 wt % DMF at room temperature, was cast on a clean glass plate, followed by an immediate immersion in a NMP/water (50/50) coagulant bath at room temperature. The polymer started to coagulate resulting in a PAN support. Upon removal from the glass plate, the PAN support was kept in a water bath overnight for completely phase separation and solvent removal.

A polyamide thin film layer was then coated onto a surface of the PAN support by an interfacial polymerization process. Briefly, the support was placed in a frame so that only the surface was exposed to the reactant. A 1.5 wt % MPD aqueous solution was cast on the surface. Excess water droplets on the surface were removed with a filter paper. Subsequently, a solution of 0.05 wt % TMC in hexane was poured on top of the MPD aqueous solution to form a polyamide thin film by polymerization between MPD and TMC. The freshly prepared polymeric thin film layer was dried in open air at room temperature for 1 min and then stored in water.

Finally, a sulfonated pentablock (Nexar™) copolymer layer was coated on the opposing surface of the PAN support by exposing it to a 2 wt % sulfonated pentablock copolymer solution for 3 min. The double-skinned membrane thus formed was dried in open air at room temperature for 1 min before being placed in water for 3 h to completely remove any excess reactants. Before the membrane was subjected to a FO test, the copolymer layer was pre-wetted by exposure to ethanol for 1 min.

The double-skinned membrane thus prepared included a porous PAN support sandwiched by two dense skins: a thin film layer and a copolymer layer.

### EXAMPLE 2

### Characterization of the Double-Skinned Membrane

Both field emission scanning electron microscopy and atomic force microscopy images of the double-skinned membrane prepared in Example 1 showed that it had a fully porous middle layer, i.e., the PAN support, consisting of some finger-like macrovoids, which might lower ICP. The presence of a rough ridge-valley morphology on one surface of the membrane indicated the formation of a first dense skin, i.e., a polyamide layer, onto one surface of the PAN support. The other surface was both smooth and dense, indicating formation of a copolymer layer onto that surface of the PAN support.

When such a double-skinned membrane is used in separating oil and water in an emulsion, its second dense skin, i.e., the copolymer layer, serves as a rejection layer for emulsified oil particles. A study was conducted to characterize the copolymer layer. The mean pore diameter (μₚ) of this layer was 9.16 nm. The size of emulsified oil particles in a lab-synthesized 200,000 ppm emulsified oil solution ranged from 50 to 8000 nm, much greater than the mean pore diameter of the copolymer layer. Thus, the copolymer layer can reject emulsified-oil particles and prevent them from entering into the porous PAN support, thereby minimizing internal fouling of the membrane.

A single-skinned membrane, which had a porous PAN support and only one dense skin, was prepared by following the method in Example 1 without coating a sulfonated pentablock copolymer layer.

Both the double-skinned and single-skinned membranes were characterized.

Image analysis indicated that the resultant double-skinned membrane had a fully porous middle layer that lowers transport resistance and ICP. The thin film layer had a surface roughness of 7.52 nm and the sulfonated pentablock copolymer layer described in Example 1 had a surface roughness of 4.36 nm. The latter layer turned out to be highly dense without any visible pores even under a high magnification, which indicated that a fully covered copolymer layer was formed on the bottom surface of the porous support.

It was found that the PWP rate of the double-skinned membrane (1.29 Lm⁻²h⁻¹/bar) was slightly lower than that of the single-skinned membrane (1.37 Lm⁻²h^{-l}/bar). The lower PWP rate was attributed to an increased flux resistance due to the presence of a second dense skin, i.e., the copolymer layer, in the double-skinned membrane.

On the other hand, the salt rejection of the double-skinned membrane remained almost the same as the single-skinned membrane at approximate 88%. This observation is consistent with the fact that the thin film layer, present in both the double-skinned and single-skinned membranes, served as a rejection layer for salts.

In addition to satisfactory water permeability and high salt rejection, the double-skinned membrane also showed a high oil rejection of >99.9%.

The results from this study demonstrated that the double-skinned membrane is suitable for FO applications to separate oil and water in an emulsion.

### EXAMPLE 3

### FO performance of a Double-Skinned Membrane and a Single-Skinned Membrane

A study was conducted to assess FO performance of the double-skinned and single-skinned membranes used in Example 2. A 0.5 M NaCl draw solution was used. A lab-synthesized 200,000 ppm emulsified oil solution and de-ionizied (DI) water served as a test feed and a control feed, respectively. The study, in which the thin film layers of both membranes faced the draw solution, was carried out for 30 min at room temperature.

The results are summarized in Table 1 below, which show that, when the feed was DI water, the water flux rate of the double-skinned membrane, i.e., 17.2 Lm⁻²hr⁻¹ (LMH), was only slightly lower than that of the single-skinned membrane, i.e., 18.5 LMH. A similar pattern (10.9 LMH vs. 11.4 LMH) was observed for the water flux rates of both membranes when the feed was a 200,000 ppm emulsified oil solution. Given that an additional resistance to flux was expected of the double-skinned membrane due to a second dense skin, the results were most surprising.

TABLE 1
FO Performance of single-skinned and double-skinned membranes

| | Water flux rate | | |
|---|---|---|---|
| Membranes | (LMH) | Feed | Draw |
| Single-skinned membrane | 18.5 | DI Water | 0.5M NaCl |
| Double-skinned membrane | 17.2 | | |
| Single-skinned membrane | 11.4 | 200,000 ppm | |
| Double-skinned membrane | 10.9 | emulsion | |

This study indicated that the dilutive ICP of a single-skinned membrane is more significant than the concentrative ICP and the copolymer layer resistance of the double-skinned membrane described in Example 1. Note that the 200,000 ppm emulsified oil solution is a highly oil-contaminated feed. Yet, the double-skinned membrane was shown to separate clean water from an emulsion at an unexpectedly high water flux rate.

Indeed, high quality of clean water (>99.9% purity) could be separated from an oily contaminated source of 200,000 ppm using the double-skinned membrane at a remarkable flux of 10.9 LMH using 0.5 M NaCl as the draw solution.

### EXAMPLE 4

### Fouling Propensities of Double-Skinned and Single-Skinned Membranes in Separating Oil and Water in an Emulsion

A study was carried out to assess the fouling propensities of double-skinned and single-skinned membranes in separating oil and water in an emulsion as follows.

A 200,000 ppm emulsified oil solution and DI water served as a test feed and a control feed, respectively. Again, the double-skinned and single-skinned membranes used in Example 2 were tested in the study, in which the initial water flux rates of both membranes were set at 11±0.5 LMH by adjusting the draw solution concentration. Internal fouling of the membrane caused a decrease in the water flux rate, which was observed over time for both membranes.

The water flux rate of the single-skinned membrane decreased more than 30% over a 6-hour operation. Unexpectedly, the double-skinned membrane exhibited a much slower decline, i.e., less than 5%, in water flux over the same period. Clearly, the second dense skin (i.e., a copolymer layer) of the double-skinned membrane acted as a rejection layer of foulants in a feed, contributing to fouling-resistance.

### Other Embodiments

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

Further, from the above description, one skilled in the art can easily ascertain the essential characteristics of the present invention, and without departing from the spirit and scope thereof, can make various changes and modifications of the invention to adapt it to various usages and conditions. Thus, other embodiments are also within the claims.

1. A double-skinned membrane comprising:
a polymeric support, 20 to 500 μm in thickness, having a first surface and a second surface opposed to each other;
a polymeric thin film layer, 1 to 1000 nm in thickness, covering the first surface; and
a sulfonated pentablock copolymer layer, 1 to 1000 nm in thickness, covering the second surface.

2. The double-skinned membrane of claim 1, wherein the polymeric support is made of cellulose acetate, cellulose diacetate, cellulose triacetate, cellulose propionate, cellulose butyrate, cellulose tributyrate, polyacrylonitrile, polyvinyl alcohol, polysulfone, sulfonated polysulfone, polyethersulfone, sulfonated s polyethersulfone, polyetherimide, polyamide, polyimide, polyamide-imide, or a combination thereof.

3. The double-skinned membrane of claim 2, wherein the polymeric support is made of polyacrylonitrile.

4. The double-skinned membrane of claim 1, wherein the thin film layer is a polyamide layer or a polyamide-imide layer.

5. The double-skinned membrane of claim 2, wherein the thin film layer is a polyamide layer or a polyamide-imide layer.

6. The double-skinned membrane of claim 4, wherein the thin film layer is a polyamide layer.

7. The double-skinned membrane of claim 3, wherein the film layer is a polyamide layer.

8. The double-skinned membrane of claim 1, wherein the membrane has a pure water permeability (PWP) rate of 0.1 to 10 Lm⁻²h⁻¹bar⁻¹, a NaCl rejection rate of 60 to 99%, and an oil rejection rate of 20 to 99.9%.

9. The double-skinned membrane of claim 8, wherein the PWP rate is higher than 1 Lm⁻²h⁻¹bar⁻¹, the NaCl rejection rate is higher than 85%, and the oil rejection rate is higher than 95%.

10. The double-skinned membrane of claim 6, wherein the membrane has a PWP rate of 0.1 to 10 Lm⁻²h⁻¹bar⁻¹, a NaCl rejection rate of 60 to 99%, and an oil rejection rate of 20 to 99.9%.

11. The double-skinned membrane of claim 10, wherein the PWP rate is higher than 1 Lm⁻²h⁻¹bar⁻¹, the NaCl rejection rate is higher than 85%, and the oil rejection rate is higher than 95%.

12. The double-skinned membrane of claim 7, wherein the membrane has a PWP rate of 0.1 to 10 Lm⁻²h⁻¹bar⁻¹, a NaCl rejection rate of 60 to 99%, and an oil rejection rate of 20 to 99.9%.

13. The double-skinned membrane of claim 12, wherein the PWP rate is higher than 1 Lm⁻²h⁻¹bar⁻¹, the NaCl rejection rate is higher than 85%, and the oil rejection rate is higher than 95%.

14. The double-skinned membrane of claim 1, wherein the polymeric support has a thickness of 40 to 70 μm, the thin film layer has a thickness of 50 to 500 nm, and the copolymer layer has a thickness of 50 to 500 nm.

15. The double-skinned membrane of claim 9, wherein the polymeric support has a thickness of 40 to 70 μm, the thin film layer has a thickness of 50 to 500 nm, and the copolymer layer has a thickness of 50 to 500 nm.

16. The double-skinned membrane of claim 1, wherein the sulfonated pentablock copolymer layer has a mean pore diameter of 5-15 nm.

17. The double-skinned membrane of claim 16, wherein the thin film layer is a polyamide layer, the polymeric support has a thickness of 40 to 70 μm, the thin film layer has a thickness of 50 to 500 nm, the copolymer layer has a thickness of 50 to 500 nm, the PWP rate of 1-10 Lm⁻²h⁻¹bar⁻¹, the NaCl rejection rate of 85%-99%, and the oil rejection rate of 95-99.9%.

18. A method of preparing a double-skinned membrane, the method comprising:
mixing 10 to 25 wt % of a polymer and 0.1 to 35 wt % of a pore former in a solvent to form a polymer solution;
casting the polymer solution on a plate;
immersing the plate in water to coagulate the polymer and deplete the pore former and the solvent from the polymer solution, whereby a polymeric support having a first surface and a second surface opposed to each other is formed;
coating the first surface of the support with a polymeric thin film layer; and
coating the second surface of the support with a sulfonated pentablock copolymer layer,
whereby a double-skinned membrane is obtained.

19. The method of claim 18, wherein the polymer is cellulose acetate, cellulose diacetate, cellulose triacetate, cellulose propionate, cellulose butyrate, cellulose tributyrate, polyacrylonitrile, polyvinyl alcohol, polysulfone, sulfonated polysulfone, polyethersulfone, sulfonated polyethersulfone, polyetherimide, polyamide, polyimide, polyamide-imide, or a combination thereof.

20-23. (canceled)

24. The method of claim 19, wherein the solvent is ethanol, dimethylformamide (DMF), dimethylacetamide, N-methyl-2-pyrrolidone, dimethylsulfoxide, 1,3-dimethyl-2-imidazolidinone, or a combination thereof.

25. The method of claim 18, wherein the first coating step is performed by an interfacial polymerization.

26. The method of claim 25, wherein the thin film layer is a polyamide layer.

27. The method of claim 25, wherein the interfacial polymerization is achieved by casting a 0.1 to 10 wt % MPD aqueous solution on the first surface of the support and then casting a 0.001 to 2 wt % trimesoyl chloride hexane solution on top of the MPD aqueous solution, whereby the polyamide thin film layer is thus formed.

28. The method of claim 27, wherein the second coating step is performed by casting a 0.05 to 10 wt % sulfonated pentablock copolymer solution on the second surface of the support, whereby the sulfonated pentablock copolymer layer is thus formed.

29. The method of claim 28, wherein the polymer is polyacrylonitrile, the pore former is lithium chloride, the solvent is a mixture of ethanol and DMF, the interfacial polymerization is achieved by casting a 1 to 2 wt % MPD aqueous solution and a 0.05 to 0.2 wt % trimesoyl chloride hexane solution, and the second coating step is performed by casting a 0.5 to 3 wt % sulfonated pentablock copolymer solution.

30. (canceled)
